(19) United States
(12) Patent Application Publication
(10) Pub. No.: US 2024/0390711 A1
(43) Pub. Date: Nov. 28, 2024

(54) CIRCUMFERENTIALLY CONTINUOUS, EXPANDABLE FIRE SUPPRESSING, DIELECTRIC SLEEVE

(71) Applicant: FEDERAL-MOGUL POWERTRAIN LLC, Northville, MI (US)

(72) Inventors: Yuki Yoneshige, Machida (JP); Emi Itoh, Kanagawa-ken (JP); Shozo Fukuyama, Tokyo (JP)

(21) Appl. No.: 18/200,523

(22) Filed: May 22, 2023

(51) Int. Cl. A62C 2/06

(52) U.S. Cl. CPC A62C 2/06

(57) ABSTRACT

A coated textile sleeve has a textile wall having a circumferentially continuous outer surface extending along a longitudinal axis between opposite open ends, wherein the textile wall is formed at least in part by flame-resistant multifilament yarn. An adhesive layer is bonded to the circumferentially continuous outer surface, and an impervious coating is bonded to the adhesive layer. The coated textile sleeve is stretchable axially and radially, thereby allowing the coated textile sleeve to flex and be easily assembled into close conforming, wrinkle-free relation about the bus-bar regardless of the number of bends and shape of the outer contour of an outer surface of the bus-bar.

### BACKGROUND OF THE INVENTION

### 1. Technical Field

This invention relates generally to textile sleeves for protecting an elongate member contained therein, and more particularly to circumferentially continuous, radially stretchable, fire suppressing dielectric textile sleeves.

### 2. Related Art

It is known to contain elongate members, such as wires, wire harnesses, cables and conduits of various types in circumferentially continuous, tubular walled sleeves to provide protection to the elongate members against impact and abrasion, fluid and external thermal affects. However, there remains a need for protective sleeving that can provide dielectric, fire suppressant protection to an elongate member contained therein, while also having a low profile and radially expandable and retractable, elastic conforming fit about the elongate member and any connectors thereof so as to not be cumbersome, unsightly and bulky, while also being impervious to dust, particles and smoke and being flexible along its length so as to be able to be routed along a serpentine path, such as along bends of the elongate member, without becoming bunched and wrinkled. There is a further need to have a protective sleeve that is able to protect the elongate member against direct exposure to flame, wherein the elongate member is a bus-bar connection between cells of a battery of an electric vehicle battery system, thereby enabling the vehicle to remain drivable under power from the battery system for at least 5 minutes after a thermal runaway condition of one or more of the cells of the battery to enable a driver of the electric vehicle ample time to maneuver to a suitable parking location and vacate the vehicle.

### SUMMARY OF THE INVENTION

One object of the disclosure is to provide a coated textile sleeve that provides dielectric, fire suppressant protection to an elongate member contained therein.

Another object of the disclosure is to provide a coated textile sleeve that is radially stretchable to allow the textile sleeve to be easily disposed about an elongate member to be contained in a circumferentially enclosed central cavity of the textile sleeve.

Another object of the disclosure is to provide protection to a bus-bar connection between portions of an electric vehicle battery pack via a coated textile sleeve to enable the battery pack to supply power to the electric vehicle for 5 minutes or more upon experiencing a problem within one or more cells of the battery pack.

Another object of the disclosure is to provide protection to a bus-bar connection between cells of a battery pack of an electric vehicle battery system to enable a driver of the electric vehicle ample time to maneuver to a suitable parking location and vacate the vehicle upon an elevated thermal condition resulting within one or more cells of the battery pack.

Another object of the disclosure is to provide thermal protection to a bus-bar connection between cells of a battery pack of an electric vehicle battery system to enable the battery system to supply power to the electric vehicle for 5 minutes or more in the event an abnormal, elevated thermal condition results within one or more of the cells of the battery pack via a coated textile sleeve having a minimal radial thickness defined by a coated, single layer textile wall.

Another object of the disclosure is to provide a coated textile sleeve that is able to bend along it length and to expand and retract radially into conformity about a bus-bar extending between batteries and/or cells of an electric vehicle battery system and into conformity about any connector(s) coupled to the bus-bar.

Another object of the disclosure is to provide a coated textile sleeve that is able to conform about a bus-bar connection between cells of a battery pack of an electric vehicle battery system in snug fitting relation about the bus-bar and about any connector attached to the bus-bar.

In accordance these and other objects, a coated textile sleeve for providing protection to a bus-bar interconnecting cells of a battery pack of an electric vehicle is provided. The coated textile sleeve has a textile wall having a circumferentially continuous outer surface extending along a longitudinal axis between opposite open ends, wherein the textile wall is formed at least in part by flame-resistant multifilament yarn. An adhesive layer is bonded to the circumferentially continuous outer surface, and an impervious coating is bonded to the adhesive layer. The coated textile sleeve is stretchable axially and radially, thereby allowing the coated textile sleeve to flex and be easily assembled into close conforming, wrinkle-free relation about the bus-bar regardless of the number of bends and shape of the outer contour of an outer surface of the bus-bar. The ability of the coated textile sleeve to stretch axially and radially is in part due to the adhesive layer's ability to prevent the impervious coating and the textile wall from interfering with each other's individual expansion and contraction properties, thereby allowing optimal and maximum expansion of each layer separated by the adhesive layer.

In accordance with another aspect of the invention, the impervious coating is a silicone-based coating.

In accordance with another aspect of the invention, the impervious coating is liquid silicone rubber.

In accordance with another aspect of the invention, the flame-resistant multifilament yarn is a mineral yarn.

In accordance with another aspect of the invention, the mineral yarn is at least one of fiberglass, silica, and basalt.

In accordance with another aspect of the invention, the textile wall is formed entirely of said mineral yarn.

In accordance with another aspect of the invention, the textile wall is configured to be disposed about a bus-bar of a battery pack of an electric vehicle.

In accordance with another aspect of the invention, the textile wall is knitted or braided.

In accordance with another aspect of the invention, the adhesive layer is a double stick tape without base, thereby minimizing any off-gassing from the adhesive layer and minimizing fuel content for flame under high heat and during exposure to flame.

In accordance with another aspect of the invention, the adhesive layer is an acrylic adhesive layer.

In accordance with another aspect of the invention, a sleeve for protecting a bus-bar connection between battery packs of an electric vehicle is provided. The sleeve consists of: a textile wall having a circumferentially continuous outer surface extending along a longitudinal axis between opposite open ends, wherein the textile wall is formed at least in part by flame-resistant multifilament yarn. Further, an adhesive layer is bonded to the circumferentially continuous outer surface, and an impervious coating is bonded to the adhesive layer.

In accordance with another aspect of the invention, a method of constructing a sleeve for providing dielectric protection to a bus-bar interconnecting portions of an electric vehicle battery pack to one another is provided. The method includes interlacing flame-resistant multifilament yarns to form a textile wall having a circumferentially continuous outer surface extending along a longitudinal axis between opposite open ends. Further, bonding an adhesive layer to the circumferentially continuous outer surface. Further yet, bonding an impervious coating to the adhesive layer, without allowing the adhesive layer to penetrate through the adhesive layer, and curing the impervious coating.

In accordance with another aspect of the invention, the method can further include forming the impervious coating from a silicone-based material.

In accordance with another aspect of the invention, the method can further include providing the silicone-based material as liquid silicone rubber.

In accordance with another aspect of the invention, the method can further include providing the flame-resistant multifilament yarns as a mineral yarns and knitting or braiding the entirety of the textile wall from the mineral yarns.

In accordance with another aspect of the invention, the method can further include causing the adhesive layer to penetrate between individual fibers of the multifilament yarns and between adjacent multifilament yarns, and causing the textile wall and the impervious coating to remain entirely separate from one another, thereby preventing the impervious coating and the textile wall from interfering with each other's individual expansion and contraction properties, and thus, allowing optimal and maximum expansion of each layer separated by the adhesive layer.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a perspective view of a motor vehicle having a coated textile sleeve constructed in accordance with one aspect of the disclosure shown disposed about an electric vehicle battery member to be protected;

FIG. 2 is a perspective view of the coated textile sleeve in accordance with one aspect of the disclosure shown disposed about the elongate member to be protected;

FIG. 3 is a perspective view of the coated textile sleeve of FIG. 2 shown prior to being disposed about the elongate member;

FIG. 3A is a cross-sectional view taken generally along the line 3A-3A of FIG. 3;

FIG. 4A is a schematic plan view of a portion of the textile layer of the sleeve illustrating the innermost textile layer being braided in accordance with one embodiment of the disclosure; and

FIG. 4B is a view similar to FIG. 4A illustrating the textile layer being knitted in accordance with yet another embodiment of the disclosure.

### DETAILED DESCRIPTION OF PREFERRED EMBODIMENTS

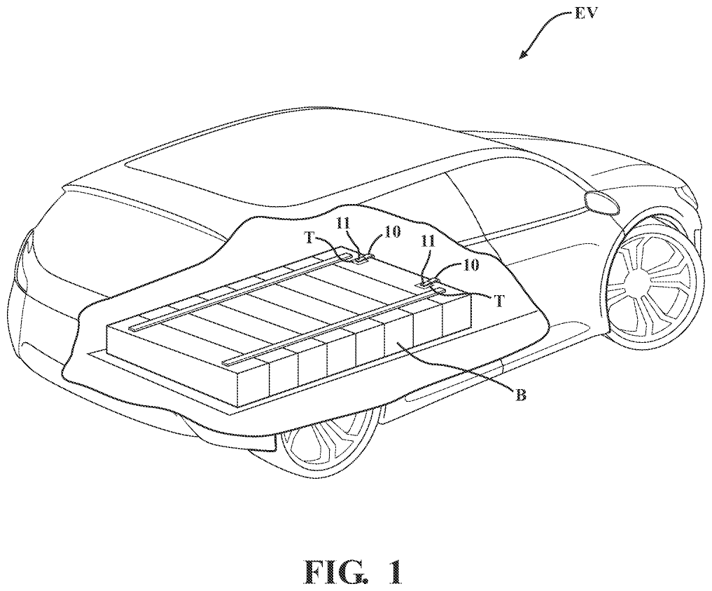

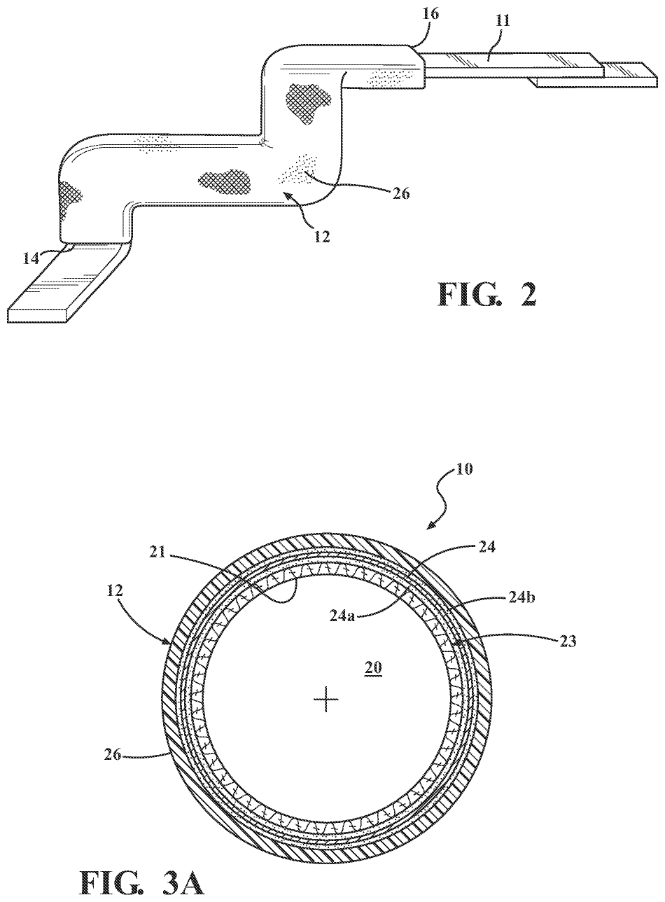

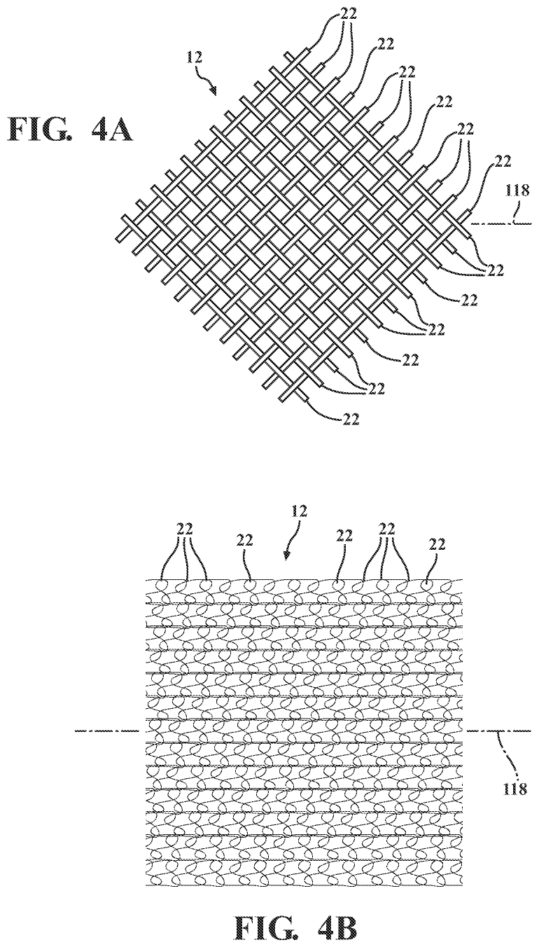

Referring in more detail to the drawings, FIG. 2 illustrates a protective coated textile sleeve, referred to hereafter as sleeve 10, constructed in accordance with one aspect of the invention having a longitudinally flexible, radially conforming wall 12 disposed and conformed, under a light contraction load, about an elongate member 11 to be protected, such as a bus-bar interconnecting portions, such as adjacent cells and/or cell modules of a battery pack, referred to hereafter as battery B (FIG. 1), of a vehicle, such as an electric vehicle EV, to one another. The wall 12 extends lengthwise between open opposite ends 14, 16 and about a longitudinal central axis 18 to bound a central cavity 20. The elongate member 11 extends through and is protected in the central cavity 20 against impact forces by the wall 12, such as may be experienced in a vehicle crash, abrasion, and ingress of contamination, by way of example and without limitation. The wall 12 suppresses flame propagation, such as in the event of thermal runaway of one or more of the cells of the battery B, thereby allowing the electric vehicle EV to remain powered by the battery for 5 minutes or more to allow the electric vehicle EV to be driven and parked, whereupon the operator can evacuate the electric vehicle EV. The wall 12 is formed in part of a single circumferentially continuous textile layer 21. The textile layer 21 is formed of flame-resistant yarn 22 (FIGS. 4A and 4B), such as in a braiding process (FIG. 4A) or a knitting process (FIG. 4B), wherein the braided or knitted yarn 22 provides radial elasticity and stretchability of the wall 12 to facilitate assembly of the sleeve 10 about the elongate member 11. The wall 12 further includes an adhesive layer 24 bonded to an outer surface 23 of the textile layer 21 and an impervious outermost coating 26 bonded to the adhesive layer 24. To facilitate the formation of a wrinkle-free, snug conforming fit of the wall 12 about the bus-bar 11, thereby facilitating assembly and the suppression of flame, having a non-bulky low profile, and being aesthetically appealing, the adhesive layer 24 and the outermost coating 26 are axially and radially elastic, thereby maintaining the axially and radially (circumferentially) elasticity of the wall 12 as knit or braided, thus, allowing the wall 12 to flex and be easily assembled into close, snug fitting relation about the bus-bar 11. Further yet, the radial expansion capacity of the wall 12, provided in part by the adhesive layer 24 keeping the underlying textile layer 21 and the overlying outermost coating 26 from inferring with one another's expansion and contraction movements, thereby maintaining the individual expansion and contraction properties of the individual layers 21, 24, 26.

The textile layer 21 can be interlaced (knit or braided) at least in part or entirely with mineral yarn multifilaments, including fiberglass, silica, and/or basalt multifilaments, as desired. If knit, any suitable knit stitch can be used to interlace the multifilaments with one another. If braided, a plain braid, wherein each multifilament extends over and under a single multifilament, can be used to optimize density and coverage, though, if desired, other braid patterns could be used. A person possessing ordinary skill in the art recognizes that both knit and braided patterns provide increases axial and radial elasticity as compared to a woven textile, and thus, it is contemplated herein that in order to maximize conformability of the wall 12 about the elongate member 11, the textile layer 21 is knitted or braided.

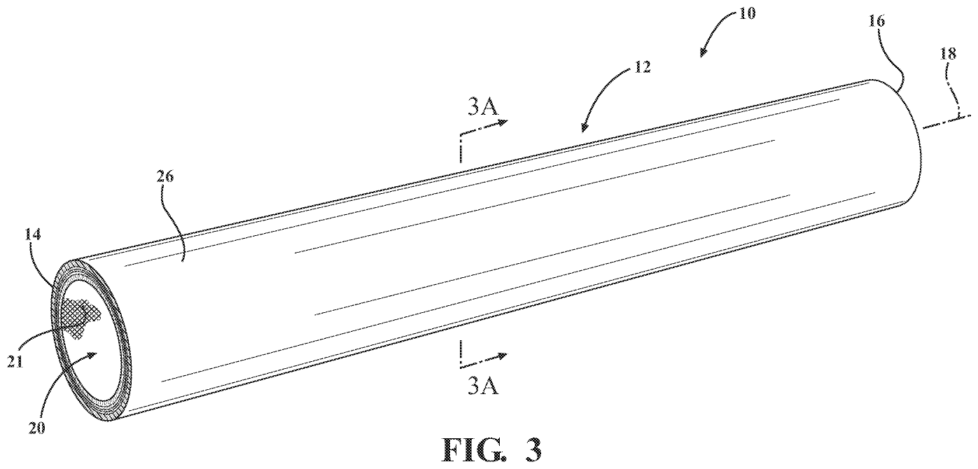

The adhesive layer 24 is provided as an acrylic adhesive. The adhesive layer 24 is sandwiched between the textile layer 21 and the outermost coating 26, and facilitate bonding the outermost coating 26 to the textile layer 21, while maintaining the elasticity of the textile layer 21 and the outermost coating 26. The adhesive layer 24 can be provided as a double-sided, double stick adhesive tape without base, meaning the adhesive layer 24 is a one-layer construction and does not include an intermediate layer of material resulting in a three-layer construction. Accordingly, the adhesive layer 24 does not include an intermediate film, textile layer, or non-woven layer, thereby minimizing any off-gassing from the adhesive layer and minimizing fuel content, which can result from an intermediate layer of material. As such, the fuel for flame propagation under high heat and during exposure to flame is minimalized by the single layer, double-sided adhesive layer 24. The single layer, double-sided adhesive tape 24 can be wrapped about, and onto, the outer surface 23 of the textile layer 21 to bring an exposed inner adhesive surface 24a (FIG. 3A) of the double-sided adhesive tape 24 into bonded relation therewith. Accordingly, the exposed inner adhesive surface 24a is adhered to the multifilament yarn 22. Desirably, the inner adhesive surface 24a penetrates between individual filaments of each filament yarn 22, while also penetrating between interlaced multifilament yarns 22, thereby increasing the bond strength and the coverage, thereby increasing the thermal protection against flame propagation. The inner adhesive surface 24a faces radially inwardly toward the central axis 18. While wrapping the double-sided adhesive tape 24 into bonded relation with the outer surface 23, a release layer, also referred to as release film 28, can be releasably adhered to an outer adhesive surface 24b of the double-sided adhesive tape 24. The outer adhesive surface 24b faces radially outwardly away from the central axis 18.

Upon bonding the acrylic adhesive layer 24 to the textile layer 21, the outermost coating 26 is applied to the textile layer 21, and in particular, on the adhesive layer 24 bonded to the textile layer 21. The outermost coating 26 is prevented from penetrating through the adhesive layer 24, and thus, does not directly contact or penetrate the textile layer 21. Accordingly, the impervious coating 26 and the textile layer 21 are kept from interfering with each other's individual expansion and contraction properties, thereby allowing optimal and maximum expansion of each layer 21, 26 separated by the adhesive layer 24. The outermost coating 26 is provided as a low viscosity silicone, silicone-based, liquid silicone rubber (LSR). The outermost coating 26 can be applied to the adhesive layer 24 using any desired process that allows the desired thickness (t) of the layer 26 to be attained. In one exemplary embodiment, the thickness t is between about 0.05 and 3 mm, and more preferably between about 0.1 and 0.3 mm. When the outermost coating 26 is provided within the aforementioned range of thickness t, flexibility and conformability of the wall 12 is optimized, and optimal dielectric strength is provided, which can provide a dielectric breakdown voltage between about 5 to 40 kV. Accordingly, the elongate member 11 is protected against unwanted electrical interference, including electromagnetic interference (EMI), radiofrequency interference (RFI), and electrostatic discharge (ESD). In addition to the various electrical protections, greatly enhanced protection to the elongate member 11 against impact forces can be provided by the outermost coating 26 in combination with the textile layer 21 and the adhesive layer 24, which provides optimal functionality, including elasticity, of the textile layer 21 and the outermost coating 26. Further yet, enhanced protection against the ingress of contamination is provided by the outermost coating 26, such as to fluid gas and solid debris, given the outermost coating 26 is hydrophobic and impervious to fluid and debris.

Upon applying the outermost coating 26 on and about the entirety of the adhesive layer 24, the outermost coating 26 is thermally cured and dried. The thermal curing process includes exposing the outermost coating 26 to heat between about 180 to 190 degrees Celsius (° C.) over a continuous period of time ranging between about 1 to 2 minutes. The cured outermost coating 26 and the textile layer 21 retain their individual flexibility and elasticity (radial expansion and contraction) in part due to the presence of the intermediate adhesive layer 24 preventing the cured outermost coating 26 and the textile layer 21 from interfering with one another.

The sleeve 10 possesses a high degree of flexibility along its entire length, while also being radially elastic so as to allow radial expansion and contraction into a conforming fit about the contour of the bus-bar 11. Accordingly, as shown in Figure XX, the sleeve 10 attains a low profile along the entirety of the bus-bar 11, including about sharp bends, without being caused to wrinkle and become bunched (gathered material). The intermediate adhesive layer 24 also contributes to optimal installation by preventing relative axial movement between the textile layer 21 and the outermost coating 26. As such, the sleeve 10 is able to perform optimally without degradation from being deformed.

Upon being exposed to an extreme heat scenario, such as during an unintended thermal runaway condition within the battery, the flame-resistant multifilament yarn 22 retain their structural integrity to suppress flame growth and propagation for at least 5 minutes or more, thereby allowing ample time for an occupant of the motor vehicle EV to park and/or evacuate the motor vehicle EV.

In accordance with another aspect, a method of constructing a thermally protective sleeve 10 is provided. The method includes interlacing multifilament flame-resistant yarn to form a textile wall 12 having a circumferentially continuous outer surface 23 extending along a longitudinal central axis 18 between opposite open ends 14, 16. The method further includes bonding an acrylic adhesive layer 24 to the outer surface 23, and then, bonding an impervious coating 26 to the adhesive layer 24, wherein the impervious coating 26 is formed of an elastomeric silicone material to enhance the stretchability and resilience of the sleeve 10. Then, the method includes curing the impervious coating 26.

In accordance with another aspect, the method includes maintaining the impervious coating 26 in spaced relation from the textile layer 21 by a thickness of the intermediate adhesive layer 24, thereby preventing the impervious coating 26 and the textile layer 21 from interfering with each other's individual expansion and contraction properties, and thus, allowing optimal and maximum expansion of each layer 21, 26 separated by the adhesive layer 24, with the adhesive layer 24 also being radially elastic.

In accordance with another aspect, the method includes forming the textile layer 21 via a braiding process.

In accordance with another aspect, the method includes forming the textile layer 21 via a knitting process.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A sleeve for protecting an elongate member, comprising:
a textile wall having a circumferentially continuous outer surface extending along a longitudinal axis between opposite open ends, said textile wall being formed at least in part by flame-resistant multifilament yarn;
an adhesive layer bonded to said circumferentially continuous outer surface; and
an impervious coating bonded to said adhesive layer.

2. The sleeve of claim 1, wherein said impervious coating is a silicone-based coating.

3. The sleeve of claim 2, wherein said impervious coating is liquid silicone rubber.

4. The sleeve of claim 1, wherein said flame-resistant multifilament yarn is a mineral yarn.

5. The sleeve of claim 4, wherein said mineral yarn is at least one of fiberglass, silica, and basalt.

6. The sleeve of claim 5, wherein said textile wall is formed entirely of said mineral yarn.

7. The sleeve of claim 1, wherein said textile wall is configured to be disposed about a bus-bar of a battery pack of an electric vehicle.

8. The sleeve of claim 1, wherein said textile wall is knitted or braided.

9. The sleeve of claim 1, wherein said adhesive layer is an acrylic adhesive layer.

10. A sleeve for protecting a bus-bar connection between battery packs of an electric vehicle, consisting of:
a textile wall having a circumferentially continuous outer surface extending along a longitudinal axis between opposite open ends, said textile wall being formed at least in part by flame-resistant multifilament yarn;
an adhesive layer bonded to said circumferentially continuous outer surface; and
an impervious coating bonded to said adhesive layer.

11. The sleeve of claim 10, wherein said impervious coating is a silicone-based coating.

12. The sleeve of claim 11, wherein said silicone-based coating is a cured liquid silicone rubber.

13. The sleeve of claim 10, wherein said flame-resistant multifilament yarn is a mineral yarn.

14. The sleeve of claim 13, wherein said mineral yarn is at least one of fiberglass, silica, and basalt.

15. The sleeve of claim 10, wherein said adhesive layer is an acrylic adhesive layer.

16. A method of constructing a sleeve for providing dielectric protection to a bus-bar interconnecting portions of an electric vehicle battery pack to one another, comprising:
interlacing flame-resistant multifilament yarns to form a wall having a circumferentially continuous outer surface extending along a longitudinal axis between opposite open ends; and
bonding an adhesive layer to said circumferentially continuous outer surface;
bonding an impervious coating to said adhesive layer; and
curing the impervious coating.

17. The method of claim 16, further including forming the impervious coating from a silicone-based material.

18. The method of claim 17, further including providing the silicone-based material as liquid silicone rubber.

19. The method of claim 16, further including providing the flame-resistant multifilament yarns as a mineral yarns and knitting or braiding the entirety of the wall from the mineral yarns.

20. The method of claim 19, further including causing the adhesive layer to penetrate between individual fibers of the multifilament yarns and between adjacent multifilament yarns.
